(19) United States
(12) Patent Application Publication
(10) Pub. No.: US 2025/0376333 A1
(43) Pub. Date: Dec. 11, 2025

(54) Tensionable belt conveyor having a robust tensioning apparatus

(71) Applicant: Kleemann GmbH, Göppingen (DE)

(72) Inventor: Tobias Köhler, Göppingen (DE)

(21) Appl. No.: 19/206,569

(22) Filed: May 13, 2025

(30) Foreign Application Priority Data
Jun. 11, 2024 (DE) 10 2024 116 290.2

(51) Int. Cl. B65G 23/44; B65G 39/16

(52) U.S. Cl. CPC B65G 23/44; B65G 39/16

(57) ABSTRACT

A tensionable belt conveyor apparatus comprises:
an apparatus frame,
a rotatable deflection roller,
a continuously revolving conveyor belt,
a bearing block, which rotatably supports the deflection roller as a tensioning deflection roller, and
a tensioning apparatus for displacing the tensioning deflection roller relative to the apparatus frame, wherein the tensioning apparatus comprises a threaded rod arrangement.
   The threaded rod arrangement comprises a first threaded rod having a first adjusting nut and a second threaded rod having a second adjusting nut, wherein the first threaded rod is fixed on a structure made up of the apparatus frame and the first bearing block as a first fixed structure so as to be translatorily immovable, wherein the respective other structure as a first support structure is physically supported in the direction toward the first fixed structure by the first adjusting nut

### RELATED APPLICATION:

The present application claims priority from German Patent Application Ser. No. DE 10 2024 116 290.2 filed Jun. 11, 2024, which is incorporated herein by reference.

### BACKGROUND OF THE DISCLOSURE

### Field of the Disclosure

The present disclosure relates to a tensionable belt conveyor apparatus for conveying mineral material. The tensionable belt conveyor apparatus comprises:
an apparatus frame,
a first and a second deflection roller, which are each supported by the apparatus frame, each deflection roller of the first and the second deflection roller being rotatable about a virtual roller axis of rotation extending transversely to the local conveying direction at the location of the respective deflection roller,
a conveyor belt continuously revolving around the first and the second deflection roller,
a bearing block arrangement having a first and a second bearing block, the first and the second bearing block supporting a deflection roller of the first and the second deflection roller as a tensioning deflection roller rotatable about its virtual tensioning roller axis of rotation, the first and the second bearing block being arranged at a distance from each other along the virtual tensioning roller axis of rotation, and
a tensioning apparatus for displacing the tensioning deflection roller relative to the apparatus frame along a displacement path running transversely to the virtual roller axis of rotation of the tensioning deflection roller, wherein for displacing the bearing block arrangement, the tensioning apparatus has a threaded rod arrangement having at least one threaded rod.

### Description of the Prior Art

Such a tensionable belt conveyor apparatus for a rock processing apparatus having a crushing device and a screening device is known from CN 103950690 A. Each of the bearing blocks of the tensioning deflection roller of the known belt conveyor apparatus is connected on opposite sides of the apparatus frame to a pull-out apparatus that can be pulled out along the conveying direction of the conveyor belt. The pull-out apparatus comprises a guide rod supporting the respective bearing block and a guide housing surrounding the guide rod. The guide housing allows for a degree of freedom of motion of the guide rod relative to the guide housing only along the longitudinal axis of the rod for moving the guide rod into and out of the guide housing.

In its end area remote from the associated bearing block, which accommodates the longitudinal end of the guide rod remote from the bearing block, the guide housing has a through-hole through which a threaded rod can pass, but through which the guide rod itself cannot pass. The threaded rod is accommodated on a holder on the apparatus frame in collinear alignment with the guide rod. The threaded rod passes through a through-hole of the holder and is in screwed engagement with an inner thread of the through-hole such that by rotating the threaded rod, the threaded rod can be moved toward the guide rod or retracted from the latter. Thus, by rotating the associated threaded rod, it is possible to displace the bearing block by way of the guide rod along the longitudinal rod axis.

An X-ray apparatus having a conveyor belt is known from GB 2 367 797 B. The conveyor belt has a powered deflection roller and a tensioning deflection roller. The tensioning deflection roller rotatable about its virtual tensioning deflection roller axis of rotation is accommodated on the apparatus frame so as to be movable along a conveyor path of the conveyor belt. A deflection roller axle physically instantiating the tensioning roller axis of rotation is loaded on both sides of the tensioning deflection roller in each case by one helical spring in a direction away from the powered deflection roller opposite along the conveyor path. While the one spring retainer is formed by the physical deflection roller axle itself, the opposite spring retainer is formed by a support plate, which has a threaded rod running through it in screwed engagement with the latter. The threaded rod itself is axially supported on the apparatus frame so that by rotating the threaded rod, the support plate can be displaced toward or away from the physical deflection roller axle. This changes the preload force exerted by the helical springs on the physical deflection roller axles.

CN 204341867 U discloses a double-chain conveyor apparatus, whose tensioning deflection shaft with chain sprockets situated thereon is displaceable by a hinged lever hinged in pivoting fashion on the apparatus frame. The tensioning deflection shaft is rotatable about a virtual tensioning shaft axis of rotation, which passes through the hinged lever between the location at which the hinged lever is fixedly hinged on the apparatus frame and the location at which a power device that pivots the hinged lever about the location at which the hinged lever is fixedly hinged on the apparatus frame. By pivoting the hinged lever about the location fixedly hinged on the apparatus frame, the virtual tensioning shaft axis of rotation and the tensioning deflection roller are also displaced as a function of the distance of the virtual tensioning shaft axis of rotation from the hinge location fixed to the apparatus frame.

The aforementioned known approaches are without exception complicated in their construction and are, such as for example in the case of GB 2 367 797 B, not suitable for application on a robust belt conveyor apparatus of a processing apparatus for processing mineral materials.

### SUMMARY OF THE DISCLOSURE

It is the objective of the present disclosure to indicate a robust belt conveyor apparatus suitable for conveying mineral material, the continuously revolving conveyor belt of which can be tensioned and directed in the most robust, simple and reliable manner to the required extent by a tensioning apparatus that is as robust and simply constructed as possible.

It is important to ensure a sufficient tension of a continuously revolving conveyor belt so that the conveyor belt is driven preferably without slip by a powered roller and that the revolving motion of the conveyor belt is as defined as possible during conveyor operation. Especially when conveying mineral material, adverse operating conditions prevail due to unavoidable mineral dusts and other contamination. If the tensionable belt conveyor apparatus is to be used on a crushing and/or screening apparatus for mineral material, there are considerable additional mechanical pulsating and changing stresses. Furthermore, during an operation of the conveyor belt, it is possible that the conveyor belt run deviates in a lateral direction from the desired course.

The present disclosure achieves the mentioned objective on a tensionable belt conveyor apparatus mentioned at the outset in that the threaded rod arrangement has at least one first threaded rod extending along a virtual first rod axis having respectively a first adjusting nut supported by the first threaded rod in screwed engagement and at least one second threaded rod extending along a virtual second rod axis having respectively a second adjusting nut supported by the second threaded rod in screwed engagement.

With at least two threaded rods, that is, at least one first threaded rod and at least one second threaded rod, it is possible to establish a stable and robust connection between the first bearing block and the apparatus frame using threaded rod stock that is always available in bulk or using always available standard components. The same is true for the at least two adjusting nuts, that is, the at least one first adjusting nut and the at least one second adjusting nut. To be sure, any component having an internal thread through which a threaded rod can pass in screwed engagement, and which in screwed engagement with a threaded rod is displaceable along the threaded rod by screw motion, is an adjusting nut in the sense of the present application. Preferably, however, adjusting nuts are standard components having standardized internal threads that match the preferred threaded rods having standardized external threads.

The described design of the tensionable belt conveyor apparatus most advantageously allows for the rectification of lateral belt run deviations.

The at least one first threaded rod is fixed on a structure made up of the apparatus frame and the first bearing block as a first fixed structure so as to be translatorily immovable relative to the first fixed structure along the virtual first rod axis. The respective other structure of apparatus frame and first bearing block is as a first support structure physically supported in the direction toward the first fixed structure by the at least one first adjusting nut.

Analogous to the at least one first threaded rod, the at least one second threaded rod is fixed on a structure made up of the apparatus frame and the first bearing block as a second fixed structure so as to be translatorily immovable relative to the second fixed structure along the virtual second rod axis, the respective other structure of apparatus frame and first bearing block as a second support structure being physically supported in the direction toward the second fixed structure by the at least one second adjusting nut.

Due to the self-locking effect of matching internal and external threads with sufficiently low thread pitch, in particular of matching standardized internal and external threads, the at least one first adjusting nut is able to form a mechanical stop for the first support structure that can be precisely positioned along the first threaded rod. The same is true for the at least one second adjusting nut in relation to the second support structure. In this way, the adjusting nuts are able to absorb high tensional forces without requiring special measures to secure the position of the adjusting nuts on the threaded rods respectively supporting them.

This makes it possible to change the distance between the first fixed structure and the first support structure along the virtual first rod axis in a simple manner by rotating the at least one first adjusting nut relative to the at least one first threaded rod about the virtual first rod axis. In the same way, the chosen construction makes it possible to change the distance between the second fixed structure and the second support structure along the virtual second rod axis in a simple manner by rotating the at least one second adjusting nut relative to the at least one second threaded rod about the virtual second rod axis.

Preferably as a rule, each threaded rod supports exactly one adjusting nut. The latter may be secured in position by a lock nut in a manner known per se.

The second bearing block of the bearing block arrangement may be arranged in any other desired manner so as to be displaceable relative to the apparatus frame. Preferably, however, it is movably connected to the apparatus frame in the same manner as the first bearing block via the tensioning apparatus. This will be explained in greater detail below.

In a particularly simple specific embodiment, therefore, exactly one first and exactly one second threaded rod having a first and a second adjusting nut suffice to position the first bearing block at a desired distance from the apparatus frame and thereby to tension the continuously revolving conveyor belt.

In principle, it is possible that the first and the second fixed structure are different components, that is, for example, that the first fixed structure is the apparatus frame and the second fixed structure is the first bearing block or vice versa. This also allows for an arrangement of the first bearing block at a defined distance from the apparatus frame. However, the adjustment of this defined distance via the two threaded rods in the mentioned constellation may be more arduous than necessary. Preferably, therefore, the first fixed structure is also the second fixed structure, so that the same component, the first bearing block or the apparatus frame, can be set in its position along the displacement path in the direction of the respective other component of first bearing block and apparatus frame, that is, toward the first and toward the same second support structure, by way of the at least one first adjusting nut and by way of the at least one second adjusting nut. As the more massive component of the two mentioned components and as the component that is normally already provided as stationary with respect to the ground at the installation location, the apparatus frame is preferably the first and/or second fixed structure. Particularly preferably, the apparatus frame is the first and the second fixed structure. Therefore, the, compared to the apparatus frame, smaller first bearing block is preferably the first and/or second support structure. Particularly preferably, the first bearing block is the first and the second support structure.

The at least one second threaded rod is preferably developed in the same manner as the at least one first threaded rod. For this reason, the statements made below regarding the at least one first threaded rod apply mutatis mutandis also to the at least one second threaded rod, the components cooperating with the at least one first threaded rod, such as the first fixed structure, the first support structure and the first adjusting nut, having to be replaced accordingly with the components cooperating with the at least one second threaded rod, such as the second fixed structure, the second support structure and the second adjusting nut.

In principle, the first threaded rod may be connected permanently to the first fixed structure, for example by welding. For several reasons, however, this is not preferable. On the one hand, the thermal deformation occurring when welding may necessitate subsequent processing to rectify it. On the other hand, a damaged threaded rod can only be replaced with substantial effort.

It is therefore preferably provided that the at least one first threaded rod passes through a first fastening formation of the first fixed structure, the first fastening formation being clamped between two clamping formations on the side of the fixed structure that are connected to the first threaded rod. Alternatively or preferably additionally, it is also preferably provided that the at least one second threaded rod passes through a second fastening formation of the second fixed structure, the second fastening formation being clamped between two clamping formations on the side of the fixed structure that are connected to the second threaded rod.

The two fixed structure-side clamping formations of the at least one first threaded rod and, respectively, of the at least one second threaded rod may be two nuts, which in screwed engagement with the respective at least one threaded rod are tightened against the respective fastening formation. Even more simply and therefore even more preferably, at least one first threaded rod of the at least one first threaded rod is a threaded shank of a screw having a screw head integrally connected to the threaded shank as a first clamping formation. Alternatively or preferably additionally, at least one second threaded rod of the at least one second threaded rod is a threaded shank of a screw having a screw head integrally connected to a threaded shank as a second clamping formation. Particularly preferably, the at least one first and/or second threaded rod is a commercially available screw, for example having a standardized thread M18, M20, M22 or greater or having a comparably sized thread of a different standard. Then it suffices to use a standardized nut as the further clamping formation in order to fix the at least one first threaded rod and/or the at least one second threaded rod on the respective fastening formation and to clamp the respective fastening formation between the clamping formations formed by the nut and screw head. At least one, preferably standardized, washer may be arranged between a screw head and/or a nut on the one hand and the respective fastening formation on the other hand.

In an alternative specific embodiment, the at least one first threaded rod and/or the at least one second threaded rod may be fixed on the respective fastening formation by a threaded engagement with the latter. For this purpose, a through-hole of the fastening formation, into which a threaded rod protrudes or through which a threaded rod passes, may have an internal thread matching the external thread of the threaded rod.

By using a screw as the at least one first and/or second threaded rod, the threaded rod may advantageously be designed to be short. It ends at the screw head, which may abut on a contact surface of the respective fastening formation.

The first fastening formation is preferably formed in one piece with the second fastening formation, for example as a materially uniform bearing section. If the fastening formation, according to a preferred specific embodiment, is formed or situated on the apparatus frame, a common fastening formation formed of the first and the second fastening formation may be a, preferably planar, sheet metal section, which has sufficient through-holes for the at least one first threaded rod and the at least one second threaded rod. To increase the stability of the mounting of the tensioning apparatus, the common fastening formation formed in this way may be connected in one piece to a further section of the apparatus frame as a bent section. However, a common fastening formation attached to and/or integrally connected with the remaining apparatus frame shall not be ruled out.

To avoid an unnecessarily high number of components, the at least one first threaded rod preferably comprises exactly one first threaded rod. For the same reason, the at least one second threaded rod preferably comprises exactly one second threaded rod.

In principle, it may suffice to fix the at least one first threaded rod on the first fixed structure so as to be only axially immovable. According to an advantageous development, a particularly simple change in position of the at least one first adjusting nut on the at least one first threaded rod by a screwing motion of the first adjusting nut without having to counter-hold the at least one first threaded rod is achieved in that the at least one first threaded rod is arranged relative to the first fixed structure so that it is rotationally immovable about the virtual first rod axis. Alternatively or preferably additionally, the at least one first threaded rod is arranged relative to the first support structure so that it is rotationally immovable about the first virtual rod axis. A rotation of the at least one first threaded rod about its virtual first rod axis is not necessary for changing the distance between the fixed structure and the first adjusting nut. Alternatively or preferably additionally, the same applies mutatis mutandis to the at least one second threaded rod. It is preferably also arranged relative to the second fixed structure and/or relative to the second support structure so that it is rotationally immovable about the virtual second rod axis.

While in the related art threaded rods, by which the distance between a tensioning deflection roller and the apparatus frame can be changed, are often situated at a distance from the tensioning deflection roller and its bearing, the tensioning apparatus of the present application is able to achieve an advantageously short structural length in that the at least one first threaded rod protrudes into at least one first receiving opening of the first support structure and/or that the at least one second threaded rod protrudes into at least one second receiving opening of the second support structure. There are preferably just as many first receiving openings as there are first threaded rods. The same applies to the ratio of the number of second receiving openings to second threaded rods.

As was already explained above, the respective adjusting nut on its threaded rod acts as a physical stop for the support structure, which is pushed toward the fixed structure by the reactive force caused by the pretensioning force generated on the conveyor belt. The respective adjusting nut thus physically limits an approach between the support structure and the fixed structure.

For the purpose of further reducing the number of components required for forming the tensioning apparatus, the tensioning apparatus is preferably free of spring components, that is, of components which by macroscopic elastic deformation exert a force acting against their deformation as a function of the degree of the deformation. To be sure, any component that is clamped, for example, by screws and nuts is also a Hookean spring in the strict scientific sense, but the spring stiffness of a component effected by the dimensions of a component and the modulus of elasticity of the respective component is so great compared to a spring stiffness of a spring component designed for elastic macroscopic deformation that the occurring forces effect only an elastic deformation, of approximately 2 mm or less, on the tensioning apparatus that is negligible considering the overall dimension of the tensioning apparatus. The at least one first threaded rod and/or the at least one second threaded rod is or are preferably made of steel, and likewise the at least one first adjusting nut and/or the at least one second adjusting nut.

The first support structure can be held in position even more securely if the at least one first threaded rod passes through a first retaining formation of the first support structure comprising the first receiving opening, the first retaining formation being clamped between two clamping formations on the side of the support structure that are connected to the at least one first threaded rod. Alternatively or preferably additionally, according to the discussed preferred development, the at least one second threaded rod may pass through a second retaining formation of the second support structure comprising the second receiving opening, the second retaining formation being clamped between two clamping formations on the side of the support structure that are connected to the at least one second threaded rod.

Advantageously, one of the clamping formations on the side of the support structure that are connected to the at least one first threaded rod may be the at least one first adjusting nut and/or one of the clamping formations on the side of the support structure that are connected to the at least one second threaded rod may be the at least one second adjusting nut. For clamping the first and, respectively, the second retaining formation, a further nut in addition to the respective adjusting nut may thus suffice, which is screwed onto the longitudinal end of the respective threaded rod that passes through the respective receiving opening.

As was described above, the first and the second support structure is preferably the first bearing block. The first bearing block is preferably at least partly formed as one piece, the first and the second receiving opening being preferably formed on a one-piece section of the first bearing block for reasons of stability and dimensional accuracy. The first and the second retaining formation thus preferably form a common one-piece retaining formation, analogous to the common fastening formation described above. Further preferably, a separate receiving opening is provided for each threaded rod, through which only one threaded rod passes.

Advantageously, a commercially available bearing block may be used as a first bearing block with a long operating life if between the at least one first adjusting nut and the first support structure at least one rigid first intermediate piece is arranged and/or if between the at least one second adjusting nut and the first support structure at least one rigid second intermediate piece is arranged. It is not necessary to provide the mentioned intermediate pieces, but they may advantageously distribute the introduction of the support force locally from the adjusting nuts into the first bearing block over a greater component surface. For these reasons in turn it is preferable if the first intermediate piece and the second intermediate piece are a one-piece common intermediate piece, which allows for a large contact surface of a contact side of the first bearing block on the common intermediate piece and thus an advantageous large- area force introduction of the support forces into the bearing block. The first and/or the second or the common intermediate piece is preferably made of metal, in particular steel.

If a plurality of first threaded rods is provided, then the first threaded rods are preferably parallel to one another. The same applies to a provided plurality of second threaded rods. The virtual first rod axis and the virtual second rod axis are preferably parallel to each other so as to allow for a change in the distance between the at least one first adjusting nut and the first fixed structure and between the at least one second adjusting nut and the second fixed structure in the same direction. This avoids unnecessary mounting forces. Still unnecessary, but sufficiently small mounting forces due to a misorientation of the virtual first rod axis and the virtual second rod axis relative to each other may be achieved in that the virtual first rod axis and the virtual second rod axis enclose an angle of no more than 15°.

Unwanted pitching moments and excessively unequal force distributions on the at least one first threaded rod and on the at least one second threaded rod may be avoided by arranging the at least one first threaded rod and the at least one second threaded rod in such a way that the imaginary extended virtual tensioning roller axis of rotation runs between the imaginary extended virtual rod axes of the at least one first and the at least one second threaded rod.

Furthermore, it is possible to do without a guide structure of the tensioning apparatus frequently present in the related art in addition to the fastening structure. The first bearing block is preferably positioned relative to the apparatus frame only by the aforementioned components, possible augmented by one or more lock nuts for improved fixation and by one or more washers.

As was already indicated above, analogous to the first bearing block, the second bearing block is preferably connected to the apparatus frame so that its distance from the apparatus frame can be changed. For this purpose, it is preferably provided that the threaded rod arrangement has at least one third threaded rod extending along a virtual third rod axis having a respective third adjusting nut supported by the at least one third threaded rod in screwed engagement and at least one fourth threaded rod extending along a virtual fourth rod axis having respectively a fourth adjusting nut supported by the at least one fourth threaded rod in screwed engagement.

The described construction of the tensioning apparatus may advantageously be used to adjust the orientation of the tensioning roller axis of rotation relative to the desired conveying direction of the conveyor belt and thus to counteract lateral belt run deviations in a simple, quick and secure manner. The tensioning apparatus may be a first tensioning apparatus, which is used on the belt conveyor apparatus in addition to a second tensioning apparatus.

The at least one third threaded rod is fixed on a structure made up of the apparatus frame and the second bearing block as a third fixed structure so as to be translatorily immovable along the virtual third rod axis, the respective other structure of apparatus frame and second bearing block as a third support structure being physically supported in the direction toward the third fixed structure by the at least one third adjusting nut.

The at least one fourth threaded rod is fixed on a structure made up of the apparatus frame and the second bearing block as a fourth fixed structure so as to be translatorily immovable along the virtual fourth rod axis, the respective other structure of apparatus frame and second bearing block as a fourth support structure being physically supported in the direction toward the fourth fixed structure by the at least one fourth adjusting nut.

Generally, what was said above about the at least one first threaded rod and the first bearing block preferably also applies to the at least one third threaded rod and the second bearing block and/or what was said above about the at least one second threaded rod and the first bearing block also applies to the at least one fourth threaded rod and the second bearing block. The same applies to the aforementioned components cooperating with the at least one first threaded rod. Identical components are able to cooperate in the same manner with the at least one third threaded rod as components described as cooperating with the at least one first threaded rod. The same applies to the at least one fourth threaded rod. With the latter, identical components are able to cooperate in the same manner as they are described above as cooperating with the at least one second threaded rod.

Preferably, the tensioning apparatus is designed symmetrically with regard to a symmetry center plane that is orthogonal to the virtual tensioning roller axis of rotation.

The belt conveyor apparatus may have more than the two mentioned deflection rollers. However, the first and the second deflection rollers are at least necessary in order functionally to separate a carrying side of the continuously revolving conveyor belt conveying mineral material from a return side returning without material.

The present disclosure also relates to a processing apparatus, in particular a self-propelled processing apparatus, for comminuting and/or sorting mineral material, comprising a material feeding device, at least one comminution device, such as a crushing device, and/or at least one sorting device, such as a screening device, and at least one tensionable belt conveyor apparatus as it described and developed above.

In a preferred specific embodiment, the present disclosure relates to a tensionable belt conveyor apparatus for conveying mineral material comprising:
an apparatus frame,
a deflection roller rotatable about a virtual roller axis of rotation running transversely to the local conveying direction,
a conveyor belt continuously revolving about the deflection roller,
a bearing block, which supports the deflection roller as a tensioning deflection roller rotatable about its virtual tensioning roller axis of rotation, and
a tensioning apparatus for displacing the tensioning deflection roller relative to the apparatus frame along a displacement path, wherein for displacing the bearing block, the tensioning apparatus has a threaded rod arrangement having at least one threaded rod.

According to the disclosure, it is provided that the threaded rod arrangement comprises a first threaded rod, extending along a virtual first rod axis, having a first adjusting nut, and a second threaded rod, extending along a virtual second rod axis, having a second adjusting nut, wherein the first threaded rod is fixed on a structure made up of the apparatus frame and the first bearing block as a first fixed structure so as to be translatorily immovable along the virtual first rod axis, wherein the respective other structure as a first support structure is physically supported in the direction toward the first fixed structure by the first adjusting nut, wherein the second threaded rod is fixed on a structure made up of the apparatus frame and the first bearing block as a second fixed structure so as to be translatorily immovable along the virtual second rod axis, wherein the respective other structure as a second support structure is physically supported in the direction toward the second fixed structure by the second adjusting nut. The advantageous developments explained above also apply to this specific embodiment.

### BRIEF DESCRIPTION OF THE DRAWINGS

The present disclosure will be explained in greater detail below with reference to the enclosed drawings. The figures show:

FIG. 1 a perspective view of an exemplary rock processing apparatus having a tensionable belt conveyor apparatus of the present disclosure,

FIG. 2 a perspective detail of a tensioning deflection roller, supported by a first bearing block, which is positioned by a tensioning apparatus on the apparatus frame in a position of maximum proximity to the apparatus frame, and

FIG. 3 the detail from FIG. 2 in which the first bearing block is maximally distant from the apparatus frame.

The figures are not true to scale but represent the relative sizes of components and assemblies accurately.

### DETAILED DESCRIPTION

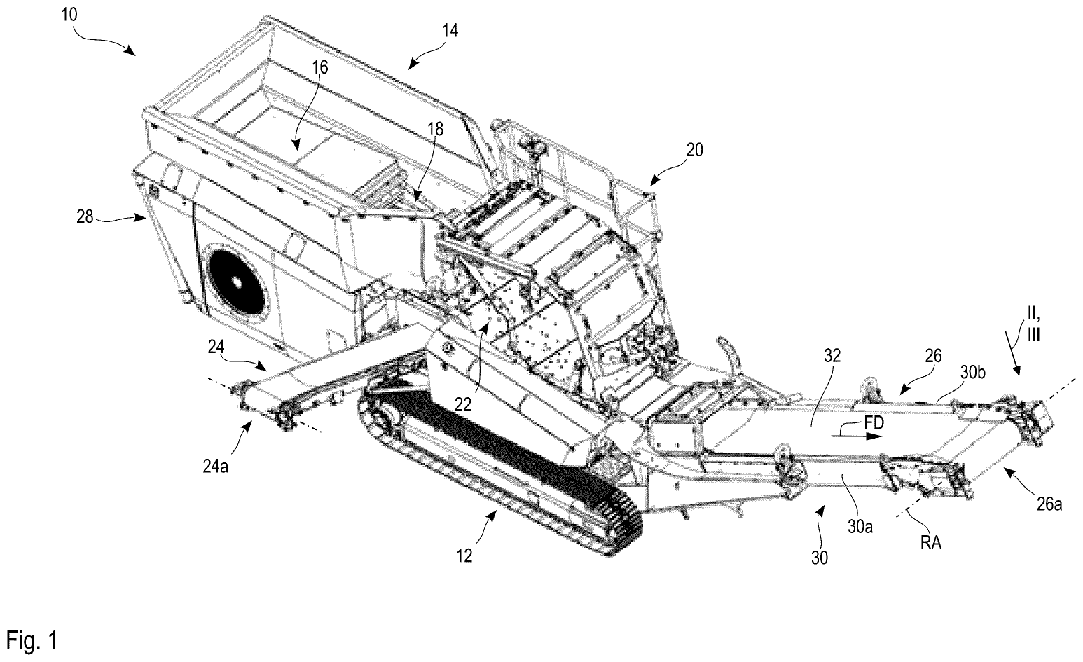

In FIG. 1, a mobile self-propelled rock processing apparatus is shown in a perspective view and generally denoted by reference numeral 10. The rock processing apparatus is supported by crawler travel gears 12, by which it can be moved between its location of use and a transporter or between two locations of use.

The rock processing apparatus 10 has a material feeding unit 14, into which mineral material is entered by suitable equipment such as a backhoe or a wheel loader.

A vibratory conveyor 16 conveys the mineral material fed into the material feeding unit 14 to a pre-screen 18 as a first screening device. The rock processing apparatus 10 additionally comprises a crushing device 20, for example an impact crusher, a cone crusher, a gyratory crusher, a roll crusher or a jaw crusher, for comminuting the fed and pre-screened (presorted) mineral material as well as one or more further screening devices 22 for sorting the mineral material comminuted by the crushing device 20 according to its grain size.

Belt conveyor apparatuses 24 and 26 convey comminuted and sorted mineral material away from the machine body 28 of the rock processing apparatus 10 onto stockpiles forming below the respective longitudinal end 24a and 26a of the belt conveyor apparatuses 24 and 26 remote from the machine body 28. The stockpiles are not shown in FIG. 1. The belt conveyor apparatus 24 is in this case a so-called “side discharge conveyor”, while the belt conveyor apparatus 26 is referred to as a “crusher discharge conveyor”. The belt conveyor apparatuses 24 and 26 are in principle identical in their construction and differ merely in the dimensions of their components and in design details of their components and assemblies, which, however, provide essentially identical functionalities.

For better clarity, only the individual components of the crusher discharge conveyor 26 are provided with reference symbols below. It is obvious, however, that the side discharge conveyor 24 comprises the essentially identical components.

Crusher discharge conveyor 26 has an apparatus frame 30, of which frame parts 30a and 30b run on both sides of a continuously revolving conveyor belt 32 essentially in parallel to the latter. A local conveying direction of the conveyor belt 32 is indicated by the arrow FD.

On the longitudinal end 26a of crusher discharge conveyor 26 projecting from the machine body 28, there is a deflection roller, not depicted in FIG. 1, of which only its roller axis of rotation RA is indicated by a dot-dash line. A further deflection roller, also not depicted in FIG. 1, is situated on the longitudinal end of the crusher discharge conveyor 26 that is closer to the machine body 28 but not visible in FIG. 1. The last-mentioned deflection roller is preferably a powered deflection roller so as to keep the energy supply of the powered deflection roller short. By contrast, the deflection roller on the projecting longitudinal end 26a is a tensioning deflection roller, which is more readily accessible for working on the tensioning apparatus of the crusher discharge conveyor 26.

The rock processing apparatus 10 from FIG. 1 is known in its basic construction and in its functionality.

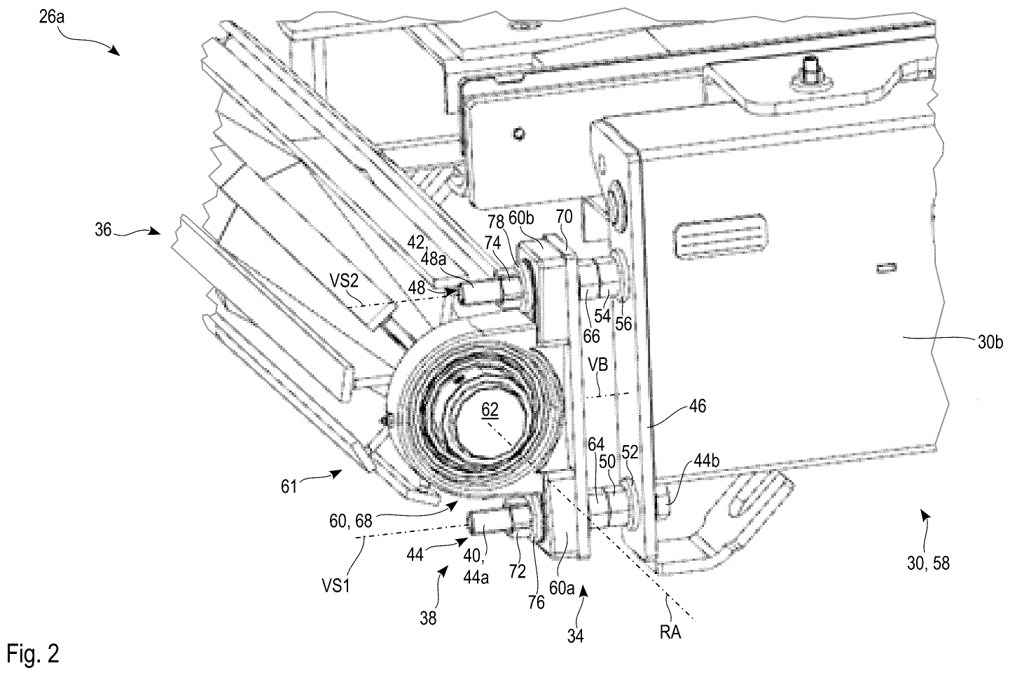

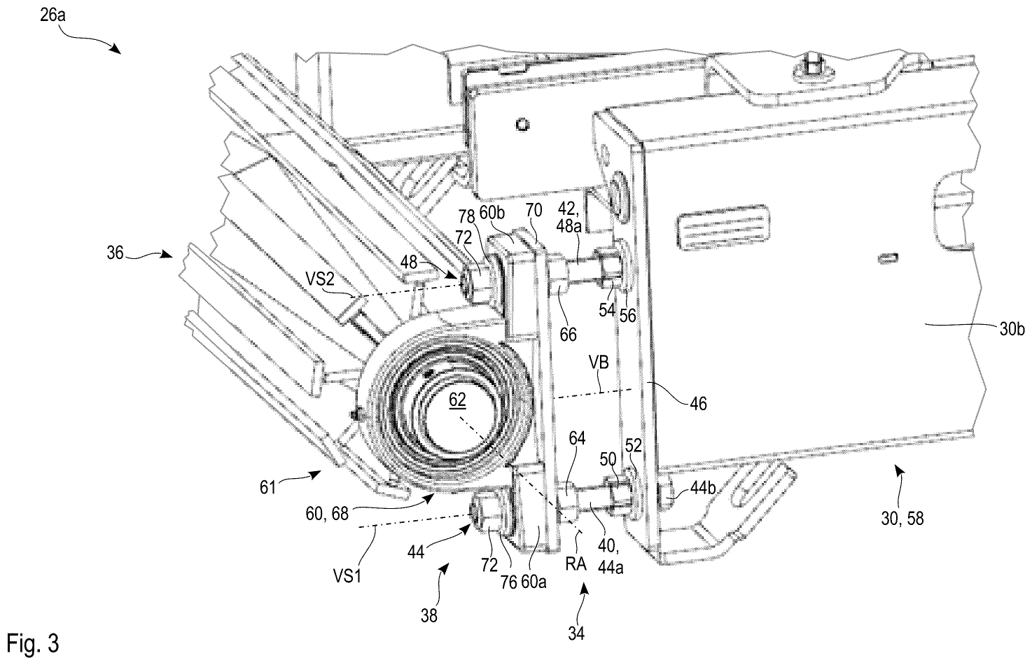

In FIGS. 2 and 3, the projecting longitudinal end 26a of the crusher discharge conveyor 26 is illustrated in cutaway portions in a perspective view from the perspective of the arrow II, III from FIG. 1. For better clarity, the continuously revolving conveyor belt 32 is omitted in FIGS. 2 and 3.

A tensioning apparatus 34 is situated on the longitudinal end of the frame part 30b which, by displacing the tensioning deflection roller 36 along a displacement path VB away from or toward the apparatus frame 30 or frame part 30b, tensions and detensions the continuously revolving conveyor belt 32 in order to ensure its failure-free operation. FIG. 2 shows the tensioning deflection roller 36 in its position of maximum proximity to the apparatus frame 30 or frame part 30b, in which a tension of the continuously revolving conveyor belt 32 produced by the tensioning apparatus 34 is lowest.

The tensioning apparatus 34 comprises a threaded rod arrangement 38 comprising a first threaded rod 40 and a second threaded rod 42. The first threaded rod 40 is a threaded shank 44a of a commercially available screw 44, the screw head 44b of which abuts on the side of a fastening plate 46 as a fastening formation facing away from the tensioning deflection roller 36.

The same holds for the second threaded rod 42. In FIG. 2, however, its screw head is concealed by the frame part 30b. The second threaded rod 42 is a threaded shank 48a of a commercially available screw 48. Screws 44 and 48 are preferably identical.

The fastening plate 46 welded to the frame part 30b is clamped on the first threaded rod 40 by the screw head 44b as a first clamping formation and by a clamping nut 50 as a second clamping formation with the interposition of a washer 52. The same holds for the second threaded rod 42 with the clamping nut 54 arranged there and the interposed washer 56. The two threaded rods 40 and 42 are thus fixed on apparatus frame 30 so as to be immovable in translatory and rotary fashion relative to the same. In the exemplary embodiment shown, the apparatus frame 30 is therefore a fixed structure 58.

A washer 52 is likewise arranged between the screw head 44b of the threaded rod 40 and the fastening plate 46. Washer 52, however, is concealed in the figures by the fastening plate 46. In the same way, a washer 52 is preferably arranged between the screw head of the threaded rod 42 and the fastening plate 46.

The tensioning deflection roller 36 is supported in a first bearing block 60 about its virtual tensioning roller axis of rotation RA. The bearing block 60 is preferably a cast component produced in one piece, which supports a rotating shaft 62 of the tensioning deflection roller 36 by way of a sleeve bearing or alternatively by way of a ball bearing or roller bearing. The first bearing block is part of a bearing block arrangement 61, which includes a, preferably identically designed, second bearing block on the opposite longitudinal end of the tensioning deflection roller 36.

The first bearing block 60 has retaining formations 60a and 60b protruding on opposite sides, which respectively have a through-hole, not shown in the figures, through which the first threaded rod 40 and the second threaded rod 42 respectively pass.

A first adjusting nut 64 is mounted on the first threaded rod 40 in screwed engagement with the first threaded rod 40. A second adjusting nut 66 is mounted on the second threaded rod 42 in screwed engagement with the second threaded rod 42. The first adjusting nut 64 and the second adjusting nut 66 limit an approach of the first bearing block 60 to the apparatus frame 30 or frame part 30b.

The first threaded rod 40 extends along a virtual first rod axis VS1, while the second threaded rod 42 extends along a virtual second rod axis VS2 in parallel to the virtual first rod axis VS1.

In the illustrated exemplary embodiment, the bearing block 60 forms a support structure 68, which can be positioned along the displacement path VB parallel to the virtual rod axes VS1 and VS2 by rotating the adjusting nuts 64 and 66 and which is supported on the adjusting nuts 64 and 66 by interposition of a one-piece intermediate piece 70.

In the illustrated exemplary embodiment, the intermediate piece 70 is a metal plate, which distributes the support forces occurring locally at the adjusting nuts 64 and 66 and reacting on the bearing block 60 onto a greater contact area of the bearing block 60 and thus reduces its local load due to the support on the adjusting nuts 64 and 66.

The bearing block 60 is secured on the threaded rods 40 and 42 by further clamping formations on the side of the support structure in the form of clamping nuts 72 and 74. Together with the first adjusting nut 64, the clamping nut 72 forms clamping formations on the support structure side, which fix the retaining formation 60a on the first threaded rod 40 by clamping it between them. Together with the second adjusting nut 66, the clamping nut 74 forms clamping formations on the support structure side, which fix the retaining formation 60b on the second threaded rod 42 by clamping it between them. To protect the retaining formations 60a and 60b, a washer 76 and 78 is respectively arranged between the clamping nuts 72 and 74 and the respective retaining formation 60a and 60b. In the same way, at least one washer is preferably arranged between the adjusting nuts 64 and 66 on the one hand and the respective retaining formation 60a and 60b. In the figure, these washers are concealed, however, by the retaining formations 60a and 60b as well as by the intermediate piece 70.

FIG. 3 shows the tensioning deflection roller 36 with its first bearing block 60 in the position along the displacement path VB maximally removed from the apparatus frame 30 or from frame part 30b. The commercially available screws 44 and 48 having the threaded rods 40 and 42 may be screws having a metric thread M20, for example.

After fixing the threaded rods 40 and 42 on the apparatus frame 30, the tensioning apparatus 34 requires no further components beyond the threaded rods 40 and 42 and the adjusting nuts 64 and 66 in order to fix the position of the virtual tensioning roller axis of rotation RA along the displacement path VB relative to the apparatus frame 30. In particular, no guide structure, such as guide rails or guide bars, is required.

A pitching moment of the first bearing block 60 on the support points of the threaded rods 40 and 42 is excluded by the fact that the imaginary extended virtual tensioning roller axis of rotation RA is situated between the imaginary extended virtual rod axes VS1 and VS2, preferably at equal distance from each of the virtual rod axes VS1 and VS2.

The longitudinal end of the tensioning deflection roller 36 opposite the virtual tensioning roller axis of rotation RA (not shown in FIGS. 2 and 3) is supported on the frame part 30a in the same way as the longitudinal end shown in FIGS. 2 and 3 is supported on frame part 30b. The support of the tensioning deflection roller 36 on the apparatus frame 30 is in mirror symmetry with regard to an axis of symmetry that is orthogonal to the virtual tensioning roller axis of rotation RA. In the illustrated exemplary embodiment with a virtual tensioning roller axis of rotation RA arranged equidistantly from the virtual rod axes VS1 and VS2, the support of the tensioning deflection roller 36 on the apparatus frame 30 is in mirror symmetry also with regard to an axis of symmetry that includes the tensioning roller axis of rotation RA and is parallel to the virtual rod axes VS1 and VS2.

1-15. (canceled)

16. A tensionable belt conveyor apparatus for conveying mineral material in a local conveying direction, comprising:
an apparatus frame;
a first deflection roller and a second deflection roller, wherein each of the first and second deflection rollers is supported by the apparatus frame and is rotatable about a respective virtual roller axis of rotation extending transversely to the local conveying direction;
a conveyor belt continuously revolving around the first and second deflection rollers;
a bearing block arrangement including a first bearing block and a second bearing block, the bearing block arrangement supporting at least one of the first or second deflection rollers as a tensioning deflection roller rotatable about a virtual tensioning roller axis of rotation, wherein the first and second bearing blocks are spaced apart along the virtual tensioning roller axis of rotation; and
a tensioning apparatus configured to displace the tensioning deflection roller along a displacement path running transversely to the virtual tensioning roller axis of rotation, the tensioning apparatus including at least one threaded rod arrangement including:
at least one first threaded rod extending along a virtual first rod axis and at least one first adjusting nut supported by the first threaded rod in screwed engagement, wherein the first threaded rod is fixed on one of the apparatus frame or the first bearing block as a first fixed structure and the other of the apparatus frame or the first bearing block is physically supported as a first support structure in a direction toward the first fixed structure by the at least one first adjusting nut; and
at least one second threaded rod extending along a virtual second rod axis and at least one second adjusting nut supported by the second threaded rod in screwed engagement, wherein the second threaded rod is fixed on one of the apparatus frame or the first bearing block as a second fixed structure and the other of the apparatus frame or the first bearing block is physically supported as a second support structure in a direction toward the second fixed structure by the at least one second adjusting nut.

17. The tensionable belt conveyor apparatus of claim 16, wherein:
the first fixed structure is also the second fixed structure.

18. The tensionable belt conveyor apparatus of claim 16, wherein:
the first fixed structure and the second fixed structure are both the apparatus frame.

19. The tensionable belt conveyor apparatus of claim 16, wherein:
at least one of the first or second threaded rods passes through a fastening formation of its respective fixed structure, and the fastening formation is clamped between two clamping formations connected to the one of the first or second threaded rods on opposite sides of the fastening formation.

20. The tensionable belt conveyor apparatus of claim 16, wherein:
at least one of the first or second threaded rods is arranged relative to its respective fixed structure or its respective support structure so as to be rotationally immovable about its respective virtual rod axis.

21. The tensionable belt conveyor apparatus of claim 16, wherein:
at least one of the first or second threaded rods protrudes into at least one receiving opening of its respective support structure.

22. The tensionable belt conveyor apparatus of claim 21, wherein:
the at least one of the first or second threaded rods passes through a retaining formation of its respective support structure having the at least one receiving opening, and the retaining formation is clamped between two clamping formations connected to the at least one of the first or second threaded rods on opposite sides of the retaining formation.

23. The tensionable belt conveyor apparatus of claim 22, wherein:
one of the two clamping formations is the first adjusting nut or the second adjusting nut.

24. The tensionable belt conveyor apparatus of claim 16, further comprising:
at least one rigid intermediate plate arranged between the adjusting nut and the first support structure or between the second adjusting nut and second support structure.

25. The tensionable belt conveyor apparatus of claim 16, wherein:
the virtual first rod axis and the virtual second rod axis enclose an angle of no more than 15°.

26. The tensionable belt conveyor apparatus of claim 16, wherein:
the at least one first threaded rod and the at least one second threaded rod are arranged such that the virtual tensioning roller axis of rotation extends between the virtual first rod axis and the virtual second rod axis.

27. The tensionable belt conveyor apparatus of claim 16, wherein the at least one threaded rod arrangement further includes:
at least one third threaded rod extending along a virtual third rod axis and at least one third adjusting nut supported by the third threaded rod in screwed engagement, wherein the third threaded rod is fixed on one of the apparatus frame or the second bearing block as a third fixed structure and the other of the apparatus frame or the second bearing block is physically supported as a third support structure in a direction toward the third fixed structure by the at least one third adjusting nut; and
at least one fourth threaded rod extending along a virtual fourth rod axis and at least one fourth adjusting nut supported by the fourth threaded rod in screwed engagement, wherein the fourth threaded rod is fixed on one of the apparatus frame or the second bearing block as a fourth fixed structure and the other of the apparatus frame or the second bearing block is physically supported as a fourth support structure in a direction toward the fourth fixed structure by the at least one fourth adjusting nut.

28. The tensionable belt conveyor apparatus of claim 16, in combination with a self-propelled processing apparatus comprising a material feeding unit and at least one comminution device or at least one sorting device.
